(19) United States
(12) Patent Application Publication
(10) Pub. No.: US 2026/0160888 A1
(43) Pub. Date: Jun. 11, 2026

(54) APPLICATION-SPECIFIC INTEGRATED CIRCUIT AND SYSTEM FOR ULTRASONIC TRANSMISSION AND DETECTION

(71) Applicant: DarkVision Technologies Inc., North Vancouver (CA)

(72) Inventors: Michael Halpenny-Mason, North Vancouver (CA); Graham T. Manders, North Vancouver (CA); Travis Blalock, Charlottesville, VA (US); Muhammad Imran Masud, British Columbia (CA)

(21) Appl. No.: 19/178,941

(22) Filed: Apr. 15, 2025

(30) Foreign Application Priority Data
Apr. 18, 2024 (GB) 2405501.4

(51) Int. Cl. G01S 15/89; G01S 7/524

(52) U.S. Cl. CPC G01S 15/89; G01S 7/524

(57) ABSTRACT

An application-specific integrated circuit (ASIC) and a corresponding system for ultrasonic wave transmission and reception. The ASIC includes a two-dimensional pulser matrix, each pulser designed to produce pulses for an ultrasonic transducer element and associated receive switches for conducting echo signals received from these elements. Integral to the ASIC is at least one multiplexer stage, communicatively coupled to the receive switches, which selectively allows subsets of echo signals to be output in response to a selection signal. This configuration allows for a dense deployment of pulsers on an ASIC, facilitating higher resolution in ultrasonic applications.

### TECHNICAL FIELD

The present disclosure relates to the design and development of application-specific integrated circuits (ASICs), particularly to ASICs designed for ultrasonic applications.

### BACKGROUND

Ultrasonic detection technology is widely used in various industries, including oil and gas drilling. This technology works on the principle of emitting high-frequency sound waves into an object or space and receiving the resultant echoes. By analyzing these echoes, it is possible to gain valuable insight into the internal structure of the object or the configuration of the space.

One component of an ultrasonic detection device is a transducer array. Each transducer in this array can act as a transmitter, generating ultrasonic waves, and as a receiver, capturing the echoed waves. The transmission of ultrasonic waves are controlled by pulsers, which are circuit elements that generate pulses of electricity to drive the transducers. The pulser effectively triggers the transmission of the ultrasonic wave. The transducer array, pulsers, and related circuitry may be implemented on an ASIC.

### SUMMARY

According to a first aspect, there is provided an ASIC for ultrasonic wave transmission and reception, the ASIC comprising: a pulser matrix comprising a two-dimensional matrix of pulsers and a two-dimensional matrix of receive switches for electrical coupling to a two-dimensional matrix of ultrasonic transducer elements, wherein each of the pulsers is configured to produce pulses for a respective one of the ultrasonic transducer elements and wherein each of the receive switches is selectively configurable to conduct echo signals generated by a respective one of the ultrasonic transducer elements in response to receiving echoes of the pulses; and at least one multiplexer stage communicatively coupled to the receive switches to receive the echo signals from the ultrasonic transducer elements, wherein the at least one multiplexer stage outputs a subset of the echo signals in response to a selection signal.

In some embodiments, the matrix of receive switches may be divided into multiple switch groups; the at least one multiplexer stage may comprise a first multiplexer stage and a second multiplexer stage communicatively coupled in series; the first multiplexer stage may comprise a switch line selectably couplable to different subsets of the switch groups such that the first multiplexer stage outputs the echo signals received from a selected one of the subsets from each of the switch groups; and the second multiplexer stage may output the echo signals from a selected one of the switch groups.

In some embodiments, each of the switch groups may comprise a grouping of one of columns or rows of the matrix of receive switches, and each of the subsets may comprise a grouping of the other of the columns or the rows of the matrix of receive switches.

In some embodiments, each of the switch groups may comprise a continuous sequence of one of the columns or the rows of the matrix of receive switches, and each of the subsets may comprise a continuous sequence of the other of the columns or the rows of the matrix of receive switches.

In some embodiments, the echo signals may be analog signals, and the switch line may select the different subsets of the switch groups in response to a digital signal, and the analog and digital signals may be routed orthogonally to each other.

In some embodiments, the matrix of receive switches may be divided into two of the switch groups, the switch line may be selectably couplable to eight different subsets of the switch groups, and any one of the subsets of either of the switch groups may consist of 64 of the receive switches.

In some embodiments, the ASIC may further comprise a digital circuit comprising an aperture controller that generates shift commands to control an aperture that enables multiple of the receive switches to concurrently conduct the echo signals. The aperture may, for example, be rectangular.

In some embodiments, the aperture controller may be configured to shift the aperture along the columns or rows in response to the shift commands.

In some embodiments, the shift commands may comprise shifting by one of the rows, shifting by one of the columns, and shifting to corresponding positions among the switch groups.

In some embodiments, the ASIC may further comprise test circuitry, and the pulses output by the at least one multiplexer stage may be routed on the ASIC to the test circuitry.

In some embodiments, the ASIC may further comprise a pulser logic circuit having a number of pulser control elements configured to generate control signals to manage timing of the pulses produced by the pulsers, and the pulser logic circuit may be configured to pulse different groups of the pulsers sequentially with a delay between pulsing of the different groups.

In some embodiments, each of the different groups of the pulsers may consist of one or more pulsers in a column or a row of the pulser matrix.

In some embodiments, the delay between the pulses produced by successive groups of the pulsers may be between approximately 200 ps to approximately 400 ps.

In some embodiments, the pulser control elements may be configured to maintain the corresponding pulsers at a ground state in response to the pulsers not receiving the control signals to produce the pulses.

In some embodiments, the ASIC may further comprise output pads accessible from outside of packaging of the ASIC and respectively communicatively coupled to the pulsers and receive switches, and the pulsers may be positioned adjacent and directly connected to respective ones of the output pads.

According to a second aspect, there is provided a system, comprising: a substrate; a two-dimensional matrix of ultrasonic transducer elements arranged on one side of the substrate; and a plurality of ASICs arranged on the other side of the substrate, each of the ASICs comprising: a pulser matrix comprising a two-dimensional matrix of pulsers and a two-dimensional matrix of receive switches each respectively electrically coupled to the two-dimensional matrix of ultrasonic transducer elements, wherein each of the pulsers is configured to produce pulses for a respective one of the ultrasonic transducer elements and wherein each of the receive switches is selectively configurable to conduct echo signals generated by a respective one of the ultrasonic transducer elements in response to receiving echoes of the pulses; and at least one multiplexer stage communicatively coupled to the receive switches to receive the echo signals from the ultrasonic transducer elements, wherein the at least one multiplexer stage outputs a subset of the echo signals in response to a selection signal.

In some embodiments, the system may comprise a tiling of M×N of the ASICs, such as at least four of the ASICs, and each of the ASICs may comprise at least 1,024 of the pulsers and receive switches. Each of M and N may be greater than 1.

In some embodiments, the matrix of receive switches may be divided into multiple switch groups; the at least one multiplexer stage may comprise a first multiplexer stage and a second multiplexer stage communicatively coupled in series; the first multiplexer stage may comprise a switch line selectably couplable to different subsets of the switch groups such that the first multiplexer stage outputs the echo signals received from a selected one of the subsets from each of the switch groups; and the second multiplexer stage may output the echo signals from a selected one of the switch groups.

In some embodiments, each of the ASICs may further comprise a pulser logic circuit having a number of pulser control elements configured to generate control signals to manage timing of the pulses produced by the pulsers, and the pulser logic circuit may be configured to pulse different groups of the pulsers sequentially with a delay between pulsing of the different groups.

According to a third aspect, there is provided a method for operating an ultrasonic imaging system, wherein the system comprises: a substrate; a two-dimensional matrix of ultrasonic transducer elements arranged on one side of the substrate; and a plurality of ASICs arranged on the other side of the substrate, wherein each of the ASICs comprises: a pulser matrix comprising a two-dimensional matrix of pulsers and a two-dimensional matrix of receive switches each respectively electrically coupled to the two-dimensional matrix of ultrasonic transducer elements; and at least one multiplexer stage communicatively coupled to the receive switches; and wherein the method comprises: generating pulses in at least one of the pulsers in at least one of the ASICs for a respective one of the ultrasonic transducer elements; generating echo signals by the ultrasonic transducer elements in response to receiving echoes of the pulses; selectively configuring at least one of the receive switches in at least one of the ASICs to conduct the echo signals; and outputting a subset of the echo signals from the receive switches by the at least one multiplexer stage in response to a selection signal.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIGS. 1A and 1B illustrate perspective views of opposing sides of a system for ultrasonic transmission and detection, according to an example embodiment comprising four ASICS.

FIG. 2 illustrates a block diagram of a Digital Variable Aperture ASIC Die found in each of the ASICs of the system of FIGS. 1A and 1B, according to an example embodiment.

FIG. 3 illustrates a block diagram of a pulser control element used in the digital circuit of each of the ASICs of the system of FIGS. 1A and 1B, according to an example embodiment.

FIG. 4 illustrates a schematic diagram of a receiving circuit used in each of the ASICs of the system of FIGS. 1A and 1B, according to an example embodiment.

FIG. 5 illustrates a schematic diagram of a top-level digital circuit used in each of the ASICs of the system of FIGS. 1A and 1B, according to an example embodiment.

FIG. 6 illustrates a receive matrix for each of the ASICs of the system of FIGS. 1A and 1B, according to an example embodiment.

FIG. 7 illustrates a schematic diagram of a routing approach for the receive matrix shown in FIG. 6, according to an example embodiment.

### DETAILED DESCRIPTION

The advancement of ultrasonic detection technology requires high resolution and accuracy, resulting in an increase in the number of transducers in the array used to transmit and receive the ultrasonic signal. This expansion, while beneficial, presents challenges in managing additional power consumption and accommodating more transducers within the limited space of an application-specific integrated circuit (ASIC). For example, excessive power can lead to overheating and potential device failure. In addition, integrating a greater number of electronic components on the same substrate can introduce problems such as crosstalk and interference, which affect signal quality and the resolution of images derived from ultrasonic echoes. This complexity extends to test and validation, where ensuring the functionality of an increasing number of transducers and pulsers becomes a challenge.

The embodiments presented in this disclosure involve an ASIC equipped with an array of pulser circuits, referred to as “pulsers”. In a particular example, this array may consist of 1,024 pulsers, and multiple ASICs may be arranged on a substrate to allow for increased resolution. For example, four ASICs may be arranged on a substrate to manufacture an array of 4,096 pulsers. Each pulser in this configuration is designed to generate electrical pulses to activate a piezoelectric element in a corresponding ultrasonic transducer, resulting in the emission of ultrasonic waves toward the target object for imaging. The ultrasonic waves reflect off the object creating echoes, which propagate back towards the transducers. Upon impacting a transducer, the corresponding piezoelectric element generates an electrical echo signal. The echo signals are respectively conducted by an array of selectively configurable receive switches for downstream processing.

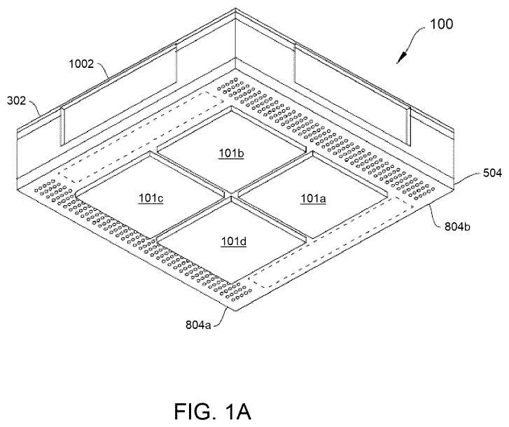

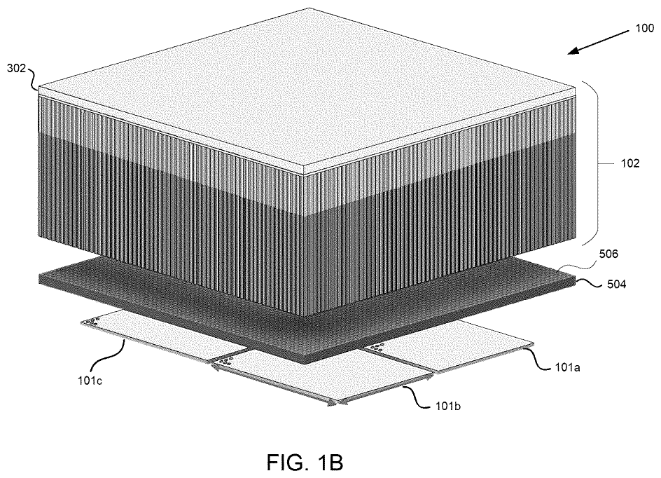

FIG. 1A illustrates a perspective view of an ultrasonic system 100 comprising a total of 4,096 ultrasonic transducer elements (not shown) organized in a dense array. Each transducer element is designed to generate and receive ultrasonic signals for imaging for any number of suitable ultrasonic imaging applications, such as for oil and gas, medical, pipeline, and non-destructive testing applications. This particular example system configuration is achieved by an ASIC assembly 101, which may comprise first to fourth ASICs 101a, 101b, 101c, and 101d, each containing 1,024 pulsers. Each ASIC comprises part of a standalone ASIC assembly. These ASICs are arranged on the same side of a common substrate, resulting in a harmonized, composite array. Although not shown in FIG. 1A, it should be understood that the assembly supports an array of 4,096 ultrasonic transducer elements realized by the cumulative pulsers embedded in the four ASICs. In some other examples, a tiling of more than 4 ASICs may be used, and each ASIC may support an array of 256, 512, 1024, 2048, 4096, etc. ultrasonic elements. On one side of the substrate, the first to fourth ASICs 101a, 101b, 101c and 101d may occupy approximately 70% of the area. In this embodiment, the pitch size of the pulsers may be between 200 μm and 500 μm, depending for example on the technology node used. The pitch in this case refers to the distance from the center of one pulser to the center of a neighboring pulser. The pitch affects the overall resolution and field of view of the ultrasonic imaging system. In at least some embodiments, the pitch of the pulsers is equal to or less than a pitch of the transducer elements, such that multiple 2D transducer arrays can be tiled in an edgeless fashion, i.e., there is no dead space between adjoining transducer arrays.

It should be understood that the area and the pitch of the ASIC may vary. For example, if the ASIC is fabricated with a smaller pitch size, the total area of the ASIC may also be relatively low. As a result, this reduction in the size of the ASIC inherently reduces the required space on the substrate of the ultrasonic system 100, potentially allowing it to occupy an even smaller area or allowing for more ASICs on the same substrate. This attribute of scale adaptability can result in more efficient use of resources and potentially lower material costs, while maintaining or even improving the performance of the ASIC. Although four ASICs are present in the depicted embodiments, there may be more or fewer ASICs on the substrate in alternative embodiments.

It should also be understood that these dimensional changes may extend to any component within the ASIC. The dimensions and configurations of any circuit or component can be adjusted to meet specific design and performance requirements while maintaining functional compatibility with the operation of the ASIC.

FIGS. 1A and 1B respectively show perspective views of opposing sides of an ASIC substrate 504. On the underside of the ASIC substrate 504, the first to fourth ASICs 101a, 101b, 101c, and 101d are electrically connected to pins of the ASIC substrate 504. A transducer substrate 302 provides structural support for the ultrasonic transducers (not shown in FIG. 1A or FIG. 1B). Additionally, a ground foil 1002 is utilized for grounding the piezoelectric (PZT) transducers, which respectively comprise part of the ultrasonic transducers. Furthermore, the ASIC substrate 504 has two distinct pin areas, 804a and 804b, designed to facilitate external access and interface with components outside of the ultrasonic system 100.

Each of the four ASICs 101a, 101b, 101c, and 101d comprises a 2-dimensional array of pulsers. These pulsers are not only electrically connected to pins 506 on the opposite side of the substrate but are also adjacent and directly connected to output pads accessible from outside of the ASIC's packaging. In an example with 4,096 pulsers, an equivalent number of pins, each corresponding to a pulser in one of the ASICs, can be disposed on the ASIC substrate 504. This one-to-one correspondence ensures a dedicated path for signal transmission from each pulser to its corresponding pin.

Further enhancing the acoustic properties and electrical connections of the system, an acoustic backing layer 102 of specified thickness and with interconnects is mounted on the ASIC substrate 504. This backing layer 102 facilitates both acoustic damping of rearward travelling acoustic waves and the routing of electrical signals upwards to a transducer substrate 302, where they reach the ultrasonic transducers. An example layer is taught in United Kingdom Patent Application GB2118476.7 filed on Dec. 17, 2021, and entitled ULTRASOUND INTERCONNECT STACK AND METHOD OF MANUFACTURING SAME. Additionally or alternatively, wires may be connected through a non-conductive damping material. The design contemplates a 2-dimensional array of ultrasonic transducer elements, each element directly associated with a corresponding pulser from one of the four ASICs. This arrangement, along with the pulsers' direct connection to the output pads, facilitates precise control and efficient signal transmission in the ultrasonic imaging process. Additionally, this architecture contributes to the overall compactness and efficiency of the ultrasound system.

The organization and integration of such a large number of pulsers into this compact system is advantageous, potentially improving imaging resolution, field of view, and other performance factors in the operation of the ultrasonic system. This configuration, enhanced by the direct connection of the pulsers to their respective output pads, provides opportunities for sophisticated control schemes and signal processing strategies for both pulse transmission and echo signal reception, offering further enhancements in ultrasonic technology.

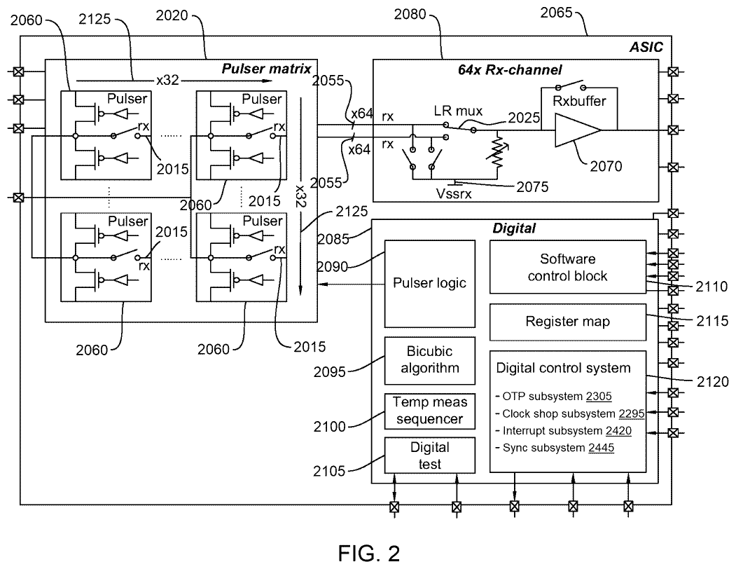

FIG. 2 illustrates a block diagram of an ASIC 2065 according to an example embodiment. The ASIC 2065 shown in FIG. 2 represents a system developed to facilitate advanced ultrasonic transmission and detection operations for 1,024 pulsers therein. The operations are typically accomplished by digital circuitry within the ASIC described herein. The use of digital control methods ensures high accuracy and provides flexibility in the operation of the ultrasonic system. The ASIC comprises a pulser matrix 2020, a top-level digital circuit 2085, and a receive (RX) circuit 2080, each with distinct functionality.

Each ASIC in the ultrasound system has a pulser matrix 2020 containing a number of pulsers 2060 arranged in a two-dimensional array, such as a 32-by-32 grid on an ASIC. This column and row arrangement can be further segmented into groups and subsets for the two dimensions, allowing for the multiplexing capabilities of the receive (RX) layout. Each pulser 2060 is a compact electronic unit containing an amplifier and a transistor, and may be communicatively coupled to an RX switch 2015. These pulsers provide fine-grained control over the generation of ultrasonic signals and the reception of echo signals, acting as both independent signal sources and receivers.

In transmission (TX) mode, the pulsers are responsible for actuating their respective ultrasonic transducers, creating hundreds or thousands of ultrasonic point sources, which combine resulting in the emission of an ultrasonic wave. After transmission, these waves interact with the target and some are reflected back to the transducers. This reflection induces physical motion in the transducer elements, such as PZTs, and thus the system enters receive (RX) mode. In this RX mode, the transducer, initially a wave emitter, now acts as a receiver, converting the mechanical vibrations of the incoming waves into analog echo signals. It should be appreciated that the RX mode can be independent of the TX mode.

The RX switches 2015 that are communicatively coupled to their corresponding pulsers 2060 serve as a multiplexer stage to conduct the received echo signals, thus reducing the number of wires needed to connect to the RX circuit 2080. The selective passage of received echo signals through the RX switches 2015 can effectively reduce the total number of signal paths and RX channels to more manageable numbers.

The RX circuit 2080 focuses on further processing of the selected echo signals. In the example shown in FIG. 2, each ASIC 2065 contains a total of 64 RX channels. Specifically, each RX channel includes a left-right multiplexer (LR MUX) 2025 in the form of a switch that is switchable between the two 64-bit buses from the pulser matrix 2020, a ground 2075, a RX amplifier 2070 (the RX amplifier 2070 may act as an amplifier and also a buffer). The LR MUX 2025 (also referred to as a 2-to-1 multiplexer as it selects between the two 64-bit buses from the pulser matrix 2020) is a device that allows signals from selected pulsers (corresponding to the selected transducers) to be routed to the amplifier 2070 for processing. The LR MUX 2025 is used to selectively connect some pulsers to the corresponding RX channel input. In the example shown in FIG. 2, each of the two inputs of the LR MUX 2025 is connected to eight different pulsers 2060 in the pulser matrix 2020.

The ground 2075 is connected to the LR MUX 2025 via two pull-to-ground switches for grounding the unselected side of the LR MUX 2025. Following the LR MUX 2025, the amplifier 2070 is provided within each RX channel to amplify the relatively weak echo signals and/or serve as a buffer before outputting to an external circuit (such as an ADC circuit).

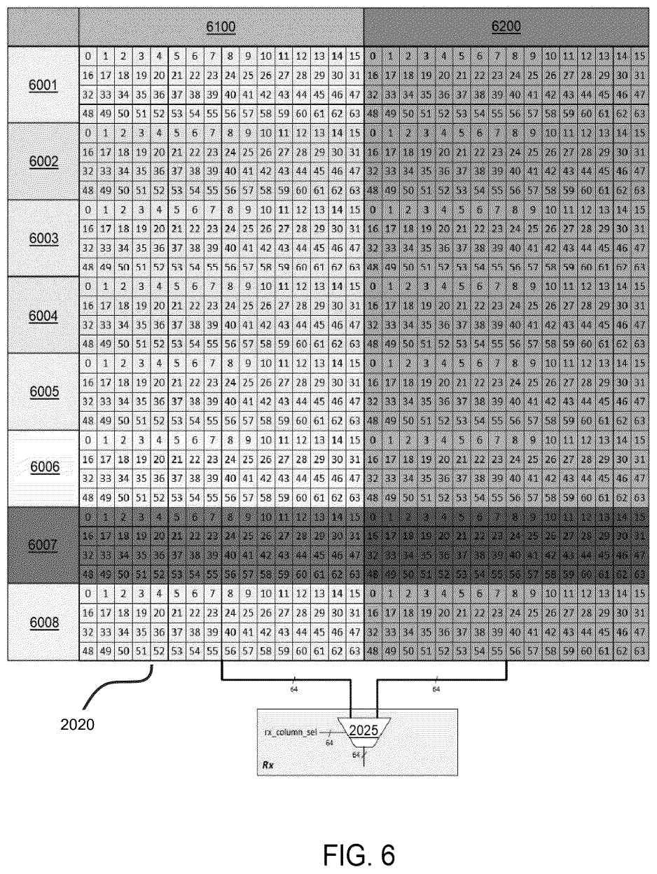

The implementation of RX switches in both the pulser matrix 2020 and the RX circuit 2080 enables a two-stage multiplexing process. This mechanism allows the 2D array of pulsers to be organized into multiple subsets and multiple groups, providing a tiered approach to signal selection. The two-stage multiplexing process is described in more detail in respect of FIG. 6, below.

While FIG. 2 illustrates a system using two stages of multiplexing, it is important to recognize the versatility of the system described herein, which can be adapted to include only a single stage of multiplexing. For example, the system may be configured to use only RX switches in the pulse matrix, bypassing the need for multiplexers in the RX circuit. Alternatively, the system may rely solely on multiplexers in the RX circuit for signal selection, eliminating the multiplexing stage at the pulser matrix level.

The digital circuit 2085 controls the overall operation of the ASIC 2065. It may include multiple circuits, such as, in this example, a pulser logic circuit 2090, a bicubic algorithm circuit 2095, a temperature measurement sequencer 2100, a digital test circuit 2105, a software control block 2119, a register map circuit 2115, and a digital control system 2120.

The pulser logic circuit 2090 controls the operation of each of the pulsers 2060, including the characteristics of the pulses such as timing, amplitude, waveform, and sequencing. The pulser logic circuit 2090 manages the states of the pulsers, deciding when each pulser should generate a pulse for transmission (TX mode) and when it should be turned on via the RX switch 2015 to receive and route echo signals (RX mode). The pulser logic 2090 is specifically focused on the pulse generation from the pulsers and the selection of pulsers for multiplexing the received echo signals. It is responsible for controlling the activation order of the pulsers, managing the pulse generation delays, activating the pulser for routing the echo signals, directing the transition of pulsers between different states such as active, pulsing, ground-hold, and high-impedance states. The pulser logic 2090 may work closely with the software control block 2110, which sets the parameters for pulse generation and handles the higher-level operation of the ASIC 2065.

The bicubic algorithm circuit 2095 is used for the calculation of delays for precise control of pulse generations across the pulse matrix. The term “bicubic” indicates the implementation of a bicubic interpolation algorithm. This algorithm is suitable for producing smooth and continuous waveforms, which are integral to the calculation of time delays as per the disclosed embodiments. By introducing calculated delays between various sets of pulsers, the algorithm ensures that only some of the pulsers are activated, so that only a limited number of pulsers generate pulses at the same time. This selective pulsing reduces the overall power requirements of the system.

As described above, the ASIC 2065, which further comprises the pulser logic circuit 2090, allows for careful management of the pulse timing of the pulsers, thereby providing precise control over the beamforming of the ultrasonic wavefront. In particular, the pulser logic circuit 2090 may be configured to pulse different sets of pulsers sequentially, introducing a delay between the activation of these sets. This sequential pulsing, particularly with a delay ranging from approximately 200 picoseconds to approximately 400 picoseconds, may provide precise phase control and prevent an unsuitably high power draw resulting from simultaneous activation of an excessive number of the pulsers. This can be achieved by coordinating the activation of all 32 pulsers within a single column or row of the 32×32 array of pulsers, rather than activating the entire array of pulsers simultaneously. It should be understood that more or fewer than 32 pulsers may be grouped as a set, and that activation orders other than sequential are possible. The staggered activation can be orchestrated by the pulser logic circuit 2090 in conjunction with the digital control system 2120 within the digital circuit 2085. In this embodiment, each ASIC may require approximately 56 watts of power to generate an ultrasonic plane wave. The strategic staggering of pulse emission, with each set of pulsers consisting of one or more pulsers in a column or row, provides balanced power distribution and prevents excessive power consumption at any one time.

The temperature measurement sequencer 2100 may handle temperature-related measurements for ensuring reliable operations of the ASIC 2065. The digital test circuit 2105 may allow for various testing operations, enabling diagnosis and troubleshooting of the system. The software control block 2110 may manage the operation of the ASIC 2065 according to the programmed instructions, and the register map circuit 2115 may act as a link between the software and hardware elements, facilitating information exchange and command issuance. For example, the register map circuit 2115 may configure and store the information on the selection of the switch group, subset, RX channel, aperture assignment, aperture shift command, etc.

In this embodiment, the digital control system 2120 comprises an OTP (One Time Programmable) subsystem 2305, a clock shop subsystem 2295, an interrupt subsystem 2420, and a sync subsystem 2445. The digital control system 2120 orchestrates the operation of the entire ASIC 2065, synchronizing its various components and their operations. The digital control system 2120 has a broader responsibility in overseeing the operation of the entire ASIC 2065. The OTP subsystem 2305 may store permanent data that is used in the operation of the device. The clock shop subsystem 2295 may help to generate clocks required for the ASIC's internal operations, while the interrupt subsystem 2420 may be used for interrupting the system upon certain events and the sync subsystem 2445 ensures synchronization or sequencing of the all of the pulsers 2060 in the ASIC 2065.

During operation, the ASIC 2065 acts as a unified entity, orchestrating the activities of the pulser matrix 2020 to generate pulses that excite the ultrasonic transducers. These transducers, in turn, emit ultrasonic waves that travel to and reflect off the target object(s). The returning waves impart motion to the transducers, creating echo signals that can be then directed to the RX circuit 2080. Integral to the system's functionality is the digital circuit 2085, which handles data processing and orchestration of various operating parameters, including pulse generation and multiplexing. Through precise digital control and strategic delayed activation of the pulsers, coupled with efficient organization of the multiplexer stage(s), the system is able to manage a substantial number of pulsers—1,024 per ASIC in the described embodiment—while utilizing far fewer RX channels, only 64 in this case. This design allows for dense integration of components, resulting in a compact footprint for each ASIC.

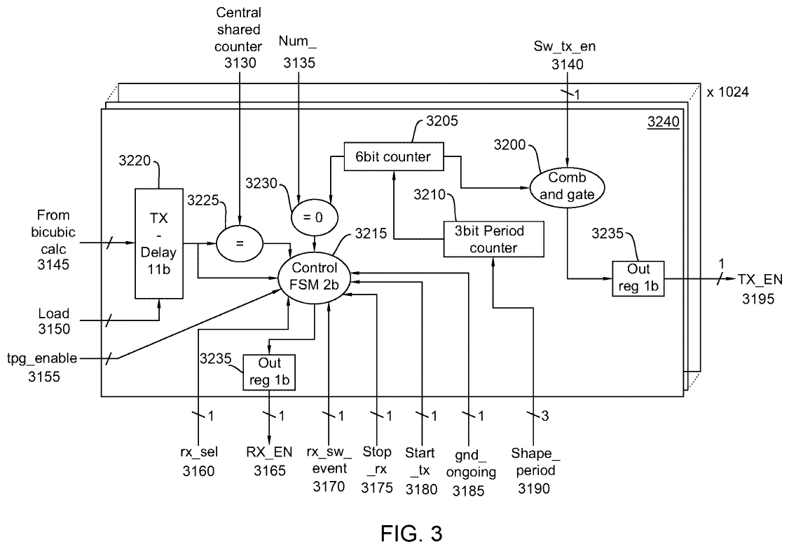

FIG. 3 illustrates a block diagram of a digital pulser control element 3240 used in the digital circuit 2085 of the ASIC 2065 (as shown in FIG. 2) as described in an embodiment herein. As shown, an array of 1,024 pulser control elements 3240 is provided, each of which is responsible for providing various control signals to its respective pulser.

The architecture is such that a load input 3150, a RX_EN output 3165, and a TX_EN output 3195 are specific to each pulser element, while other inputs are common to all 1,024 pulser elements. The heart of the control element is a central shared counter 3130, which is used to synchronize the firing sequence of the pulsers. This counter may operate at a frequency of 100 MHz and can count up to 16 bits, providing the granularity for delay calculation in the transmission process.

A bicubic calculation input 3145 provides the pulser control element 3240 with TX-delay information (11 bits), labeled 3220, for setting the individual timing of each pulser for beamforming purposes. Each pulser control element 3240 stores its local TX-delay, obtained from the bicubic calculation, to be applied on a TX-start event (Start_TX 3180).

A sw_TX_en input 3140 ensures that a pulser will only transmit after a TX-start event if this signal is asserted, which is determined by the logical AND of the global transmit enable and the negation of an individual pulser's disable signal (via a combinatorial logic gate 3200).

A control FSM (Finite State Machine, 2-bit) 3215, influenced by a 6-bit counter 3205 and a 3-bit period counter 3210, dynamically manages the pulse timing by comparing the current count to the TX-delay value. The result of this comparison determines whether the FSM 3215 triggers an out register 3235, ultimately enabling the TX_EN output 3195 that initiates pulse transmission.

Additionally, a RX_sel input 3160 decides if the pulser's RX switch should be closed following the delay, allowing the pulser to transition into the RX mode at the appropriate time. The decision may be dependent on a RX_sw_event input 3170, which represents a control input that triggers the RX switch in the pulser. The transition can be realized by another out register 3235 and then a RX_EN output 3165.

A shoot of the pulse is defined by a period between the start_TX input 3180 for initiating the transmission phase and a stop_RX output 3175 for terminating the reception phase (the pulser may be held to ground between successive shoots to reduce interference). The shape profile, determined by the register settings for the pulse-train, the number of bits used from the shape profile, and the duration of each bit, is transmitted LSB (Least Significant Bit) first from the pulser once the TX-delay has elapsed and the sw_TX_en signal is asserted.

The diagram also illustrates additional control signals, such as a load signal 3150, which enables the loading of timing parameters for the TX-delay block 3220, and a tpq_enable input 3155, which may be used to enable test patterns or diagnostic modes.

A gnd_ongoing input 3185 is indicative of a control line that maintains the pulsers in a ground state (zero potential), where they are prepared to either transmit or receive without actively doing either, providing a baseline or “rest” state for the pulsers. A shape_period input 3190 sets the duration of each bit within a shape profile, defining the temporal resolution of the ultrasonic pulses. The shape profile/pattern defines the overall pulse shape (frequency and period of each pulse along with its repetition).

A Num input 3135 allows for the selection of specific pulsers within a larger array for targeted activation. A comparator 3225, along with an equality checker 3230, serves as a part of the logic that determines when the central shared delay count matches the TX-delay, enabling precise timing for pulse emission.

The overall architecture as depicted in FIG. 3 is a highly integrated control system designed to manage the timings and sequences required for effective beamforming in ultrasonic imaging systems according to various embodiments. The role of each component, whether for managing the state of the pulsers, managing timing sequences or integrating control signals, contributes to the precise functionality of the ASIC in high-resolution ultrasonic applications. It should be appreciated that the pulser control element topology shown in FIG. 3 is only one possible example of how such a system may be configured. Those skilled in the art may conceive of alternative designs or configurations that adhere to the inventive principles and objectives disclosed herein. The scope of the disclosure should not be construed as being limited to the specific embodiments shown, but rather is intended to encompass any modifications or alternative arrangements which are within the scope of those skilled in the art and which achieve the same advantageous results.

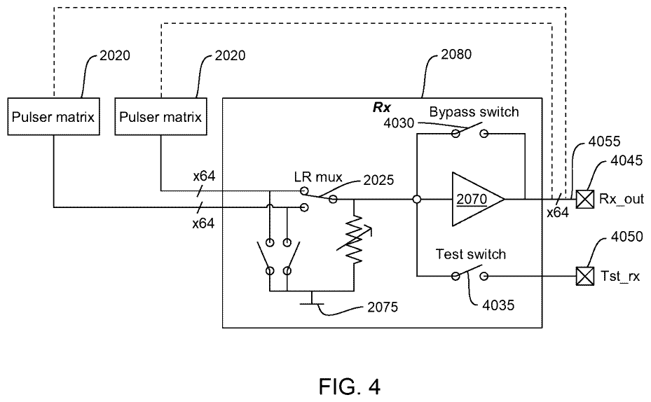

FIG. 4 illustrates a schematic diagram of the RX circuit 2080 used in the ASIC 2065 (as shown in FIG. 2) according to an embodiment described herein. The same reference numbers are used to indicate the same elements described in relation to FIG. 2.

The receiving process in this embodiment begins with the reception of ultrasonic waves by the array of transducers, as described above, which are connected to their corresponding pulsers in the ASICs. The ultrasonic waves, as they strike the transducers, are converted into corresponding electrical signals, referred to as echo signals in this disclosure, each signifying the intensity of the received ultrasonic echo. This generation of echo signals from the received ultrasonic waves is the first step in the formation of the image of the target object or region.

In this embodiment, the LR MUX 2025, as described above in respect of FIG. 2, selects one of two signal lines from the pulser matrix 2020, either in response to a control signal from digital circuit 2085, for example, or in response to its internal control logic. In this way, the RX circuit 2080 acts as the second multiplexing stage and each RX channel selects one of the two incoming echo signals, resulting in the 64-bit output of the RX circuit 2080.

In addition to the use of the ground 2075, there may be provided a programmable pull-down resistor, which is connected between the input of the amplifier (buffer) 2070 and the ground 2075.

The selected signal from the LR MUX 2025 then passes through the amplifier 2070, which is used to amplify the selected signal or act as a buffer, and then output via a 64-bit output bus 4055. The output signals, collectively referred to as RX_out 4045, are then forwarded for further processing by, for example, an external circuit such as an analog-to-digital converter (ADC). A bypass switch 4030 is provided in parallel with the amplifier 2070, providing an alternative path for the signal, bypassing the amplifier 2070 if desired (such as when a RX channel is disabled and the amplifier or buffer is put in a low-power state). A test switch 4035 may also be provided in each RX circuit 4015. This test switch 4035 provides a path for signal testing and troubleshooting for the ASIC, allowing diagnosis and correction of any problems that may arise in the signal path.

In ultrasonic detection, the ADC facilitates the processing of the echo signals received from the ultrasonic transducers, for converting the analog echo signals output by the RX circuit 2080 into digital formats that can be manipulated by the system's digital processing units. These units may be external to the ASIC. In particular, after signal selection by the second multiplexer stage, the analog signals may be amplified to increase their strength and make them suitable for analog-to-digital conversion. Amplification is beneficial when dealing with weak echo signals, as it raises their voltage levels to ensure effective digital conversion and subsequent processing. After amplification, these amplified signals are then fed into the ADCs for conversion to digital data, which is for analysis and interpretation in the ultrasonic system.

For validation purposes, in the transmission path, a redirection configuration (not shown) allows the pulsers to redirect the pulses they generate in the opposite direction. Instead of sending the pulses to the ultrasonic transducers, they are redirected directly to the RX circuit. This redirection approach does not require any additional space on the ASIC, allowing the transmitted signal to be captured efficiently for validation purposes. The redirected signals can then be passed out of the ASIC to an external ADC (through the bypass switch 4030 or the test switch 4035, for example). The resulting digital signals can be compared to the original pulse pattern generated by the pulser logic circuit 2090. This comparison is for debugging the ASIC, as it serves to validate the performance and accuracy of the pulsers in transmitting the intended pulse sequences.

On the reception side, the ultrasonic waves, once reflected and received by the transducers, are converted back into electrical (echo) signals and directed to the respective pulsers. These signals are then channeled through the RX channels. Regardless of whether they are amplified or not, the received echo signals may exit the RX circuit, for example, via the bypass switch 4030 or test switch 4035.

To extend the functionality of the digital control system within the ASIC, several test and diagnostic features may be incorporated. The system may include a parallel digital test bus that allows observation and manipulation of internal signals for thorough system analysis and troubleshooting. This test bus facilitates real-time monitoring and control, ensuring overall system integrity. In addition, the system may incorporate a digital test multiplexer that allows precise mapping and observation of internal digital signals. This feature is for detailed system testing and validation, ensuring that each digital component functions as intended.

In the area of pulse control, a dedicated test pattern generation mode may be included. This mode is for testing the system's analog components, particularly the pulsers and the RX paths (analog signals are typically converted to the digital form for testing, such as by an external ADC). It simulates operating conditions (such as by redirecting the pulses as described above), allowing extensive testing of system response and performance. As shown by the dashed lines in FIG. 4, after the pulses are multiplexed by the pulser matrix 2020, they may be routed on the ASIC to the RX_out 4045 and further to the test circuitry. By this way, the analog RX circuit can be bypassed, and the test circuitry can assess the pulses directly.

In some embodiments, the system's array of pulsers generates ultrasonic pulses, each pulser regulated by two dedicated 32-bit registers: one for pulse generation and the other for ground hold. These registers precisely dictate the pulse pattern and the ensuing ground hold period. Following pulse emission, each pulser enters a ground hold state as defined by its 32-bit register, thereby preventing any interference with incoming signals. This control over pulse generation and reception, coupled with the detailed 32-bit structure, ensures a high level of precision and flexibility in signal handling, leading to enhanced ultrasonic image quality and accuracy.

Additionally, the system may incorporate a “ground hold” feature, maintaining a reference or ground level for the electrical signals when not transmitting. This ground hold establishes a zero potential state in the transducer elements, effectively inhibiting spurious signal generation or electromagnetic interference. Such interference could adversely affect the ultrasonic signals at the onset of transmission, compromising the imaging process. By integrating ground hold, the system not only stabilizes but also optimizes its operational environment, ensuring noise-free and accurate ultrasonic imaging.

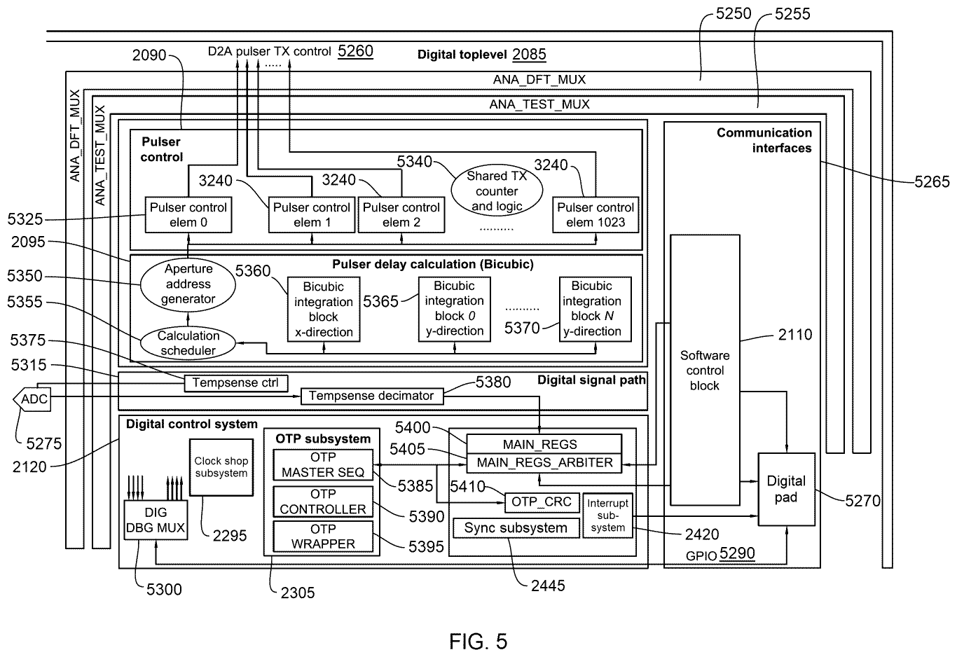

FIG. 5 illustrates a schematic diagram of the digital circuit 2085 used in the ASIC 2065 (as shown in FIG. 2) according to an embodiment described herein. The same reference numbers are used to indicate the same elements described in relation to FIG. 2.

The bicubic algorithm circuit 2095 is provided to calculate delays for the pulsers, and comprises a calculation scheduler 5355, an aperture address generator 5350 connected to the calculation scheduler 5355, and a series of bicubic integration blocks 5360, 5365, 5370 each connected to the calculation scheduler 5355. As described above, the bicubic algorithm circuit 5320 mainly focuses on calculating the delays required to control the pulsers efficiently. Within this circuit, various subcomponents work together to achieve this.

Starting with the calculation scheduler 5355, this component acts as the central coordinating unit for the bicubic algorithm circuit 2095. It schedules the execution of different calculation tasks and ensures that the necessary information is routed to the correct places within the bicubic algorithm circuit 2095. For example, it may determine the order of delay calculations based on imaging requirements or the specific sequence of pulses required.

The aperture address generator 5350, coupled to the calculation scheduler 5355, is responsible for generating the specific addresses that correspond to a desired aperture or windowing of the ultrasonic imaging process. For example, it may define particular regions to be imaged at a particular time by allowing a desired number of RX switches, typically from adjacent pulsers (hence “aperture”), to route the echo signals. This can be achieved by sending control signals to the RX switches of the desired pulsers. As described above, the aperture can also be dynamically adjusted by shift commands, together with or independent of the control signals, allowing precise scanning within or across different subsets and/or groups of pulsers.

The bicubic integration blocks 5360, 5365, 5370 work collectively with the calculation scheduler 5355 to perform intricate delay calculations. Each of these blocks may specialize in a specific aspect of the calculation or work in parallel to achieve more complex delay patterns.

The pulser logic circuit 2090 is arranged to generate various control signals for the operation of all of the pulsers that determine whether particular pulsers are activated and what delay is applied to the pulsers, which are fundamental to the generation of the electrical signal characteristics for the generation of ultrasonic waves. This circuit comprises the pulser control elements 3240 as detailed in the description of FIG. 3, with a total of 1,024 such elements being incorporated in this embodiment. Each individual pulser control element 3240 is used to provide digital control signals to the TX control component 5260 of its associated pulser, which then performs the digital-to-analog conversion for pulse shaping.

In addition, a shared TX counter and logic component 5340 is implemented to serves as a central hub that coordinates the timing and sequence of the control signals generated by the pulser control elements. The shared TX counter and logic component 5340 may include counters that ensure the proper phasing and timing of each pulse, logic circuits that interpret the instructions from the aperture address generator 5350, and other components that maintain synchronization across all 1,024 pulser control elements. In a practical scenario, it may coordinate the pulser control elements to focus the ultrasonic waves at a particular angle and depth, achieving better image clarity.

An ADC 5275, typically a component external to the digital circuit 2085, is connected to a temperature sensing control component 5375 and a temperature sensing decimator 5380, which collectively form temperature sensing logic. The ADC 5275 is responsible for converting the analog temperature measurements into digital form, enabling further processing and analysis. The temperature sensing control component 5375 helps in managing and possibly compensating for temperature variations that could affect signal characteristics, maintaining the integrity and accuracy of the data. Meanwhile, the temperature sensing decimator 5380 reduces the data rate of the digital signal by selectively removing some data points, thus streamlining the information for more efficient processing without losing critical information.

As described in respect of FIG. 2, the digital control system 2120 is a structure comprising the following subsystems: clock shop subsystem 2295, the OTP subsystem 2305, the interrupt subsystem 2420, and the sync subsystem 2445. The digital control system 2120 also includes a digital debug multiplexer (DBG MUX) 5300, which facilitates system monitoring and troubleshooting.

The digital circuit 2085 includes a main register component 5400 that stores ASIC configuration data. There may also be a main register arbiter component 5405 that ensures conflict-free data access, which forms the register map circuit 2115 together with the main register component 5400. An OTP cyclic redundancy check (CRC) component 5410 is also provided, which is connected to the main register arbiter component 5405 to confirm data integrity.

The OTP subsystem 2305 may deal with one-time programmable (OTP) memory. The OTP subsystem 2305 includes an OTP master sequencer (SEQ) 5385, which is connected to the main register arbiter component 5405 and the OTP CRC component 5410, to manage memory operations, an OTP controller 5390 for secure access to the OTP memory, and an OTP wrapper 5395 that acts as an interface layer. Together, these interrelated components enable precise control, synchronization, and verification within the ASIC. Such control is beneficial in applications requiring high accuracy and reliability.

The digital circuit 2085 also comprises communication interfaces 5265 that includes the software control block 2110, a digital pad 5270, and a general purpose input/output (GPIO) 5290. The software control block 2110 sends control signals to the main register component 5400 and the main register arbiter component 5405 in the digital control system 2120, and to the digital pad 5270. The digital pad 5270 also receives signals from the interrupt subsystem 2420 in the digital control system 2120.

The communication interfaces 5265 also comprises a GPIO 5290 that provides flexible connectivity, allowing for custom configurations and interactions with various external devices or subsystems. Together, these components offer comprehensive communication capabilities, enabling the ASIC to interact with various internal and external systems and adapt to changing requirements.

Within the digital circuit 2085, the embodiment may also include an analog design-for-test multiplexer (ANA DFT MUX) 5250 and an analog test multiplexer (ANA TEST MUX) 5255 that benefit the system's test framework. The ANA DFT MUX 5250 streamlines the diagnostic process by directing test patterns into the analog domain of the circuit, allowing functional checks, such as stress testing an analog filter with varying voltages and frequencies. In contrast, the ANA TEST MUX 5255 serves for the later stages of production and on-site verification, enabling examination of specific analog components, such as measuring the gain and linearity of an amplifier. The integration of these multiplexers facilitates detailed and robust validation of the digital circuit 2085, increasing the overall reliability.

It should be appreciated that the digital circuit topology shown in FIG. 5 is only one possible example of how such a system may be configured. Those skilled in the art may conceive of alternative designs or configurations that adhere to the inventive principles and objectives disclosed herein. The scope of the disclosure should not be construed as being limited to the specific embodiments shown, but rather is intended to encompass any modifications or alternative arrangements which are within the scope of those skilled in the art and which achieve the same advantageous results.

FIG. 6 presents the configuration of a pulser matrix for an ASIC as described in this disclosure. As described in respect of FIGS. 2 and 4, two multiplexing stages may be adopted for the ASIC 2065. The first multiplexing stage uses the RX switches 2015 to select echo signals from one of X subsets of pulsers (i.e., an X-to-1 multiplexing, where X is 8 in this example). This selection activates a group of 128 pulsers for routing echo signals, meaning that these pulsers allow the echo signals to pass through. Next, the second multiplexing stage selects echo signals from one of Y groups of pulsers. This selection is made via specific input lines leading to the LR MUX 2025 in the RX circuit 2080, which forms a Y-to-1 multiplexing, where Y is 2 in this example. Consequently, the two stages result in a 64-bit output of the RX circuit 2080. In addition to the two multiplexing stages, the system may include an aperture mechanism that selectively activates a portion of RX switches.

In FIG. 6, the top section shows the 32×32 pulser matrix 2020 previously discussed. In this particular configuration, the matrix is structured into a two-dimensional array that is categorized into two distinct switch groups, 6100 and 6200, and further segmented into eight distinct subsets, labeled 6001 through 6008. The numbers 0-63 associated with the RX switches as shown in FIG. 6 represent the corresponding number of the RX channel. This hierarchical division into groups and subsets is employed to ensure that only selected pulsers are engaged at any one time, thereby allowing a reduced number of RX circuits to manage the incoming echo signals effectively when the matrix is operating in RX mode.

In the described embodiment, the subsets 6001-6008 correspond to the first multiplexer stage, while the switch groups 6100 and 6200 correspond to the second multiplexer stage. It should be noted that the specific count of groups and subsets can be tailored to meet varying operational requirements; for instance, pulsers may be organized into four groups and four subsets to synchronize with 4-to-1 multiplexers within the RX circuit. In addition, although the current illustration depicts groups as columns and subsets as rows, this orientation can be adjusted—either groups or subsets can be set as columns, as needed.

As previously mentioned, each pulser in the system is communicatively coupled to a RX switch 2015, the operation of which is controlled by a digital signal from the digital circuit 2085. The activation of these RX switches 2015 is for channeling the echo signals towards the designated multiplexer 2025 in the RX channel. The first multiplexer stage in this example is embodied as an 8-to-1 selector and is communicatively coupled to the RX switches through a switch line (not depicted). Consequently, this first multiplexer stage selectively outputs only one echo signal subset at a time, based on a selection signal received from the digital circuit. This selection signal may be generated following predetermined criteria, which may include a programmed delay between the activation of adjacent subsets, for example. Such a configuration ensures orderly and efficient processing of the echo signals.

For instance, when subset 6007 is activated, the RX switches for each of the four rows of pulsers are turned on, so the pulsers #0 to #63 in switch group 6100 and the pulsers #0 to #63 in switch group 6200 are allowed to route the echo signals, if received, towards their respective multiplexers 2025. At this time, all other subsets 6001-6006 and 6008 are turned off, so that none of the pulsers in these subsets is allowed to route echo signals.

Following the selection by the first multiplexer stage, which narrows down the choices to one out of eight pulsers, a set of 128 signal paths proceed into the RX circuit, incorporating the 64 RX channels. Each RX channel is configured to handle two distinct signal paths from two separate switch groups 6100 and 6200, facilitating the second multiplexer stage. For instance, one input path per RX channel is configured to capture echo signals from eight pulsers across eight different subsets within one of the switch groups, like pulser #0 from each subset (6001-6008) in switch group 6100. Conversely, the alternate input path for each RX channel is capable of receiving echo signals from an analogous set of eight pulsers in the eight subsets of the other switch group, exemplified by pulser #0 from each subset (6001-6008) in switch group 6200. The selection of the second multiplexer stage can be triggered by an internal signal within the RX channel or by an external signal from the digital circuit, for example. This dual-path configuration within each RX channel allows the second stage of multiplexing, reducing the output lines to 64. In other words, by the two stages of multiplexing, the echo signals from 64 pulsers delimited by the same subset and the same group are routed to the 64 RX channels for further processing (such as for amplification).

Building on the multiplexing strategy outlined above, it is worth noting the nature and routing of the signals involved in the process. The echo signals captured and processed through this multiplexing system are analog signals, while the selection mechanism within the multiplexer stages, particularly the one that selects between the different subsets of the switch groups, operates in response to a digital signal. In this disclosure, an architectural consideration is the orthogonal routing of analog and digital signals. This means that the paths for analog echo signals (communicatively coupled to the second multiplexer stage) and digital control signals (communicatively coupled to the first multiplexer stage) are perpendicular to each other within the circuit. Such an arrangement significantly reduces the potential for interference between these two types of signals, ensuring the integrity and clarity of the analog echo signals while maintaining the precision and effectiveness of the digital control mechanisms.

The multiplexing approach described herein significantly reduces the area required for the analog circuitry on the ASIC. As a result, approximately 70% of the ASIC area is dedicated to the pulsers, allowing a greater number of pulsers to be integrated on the same ASIC. This efficient use of space ensures that the system can support 4K resolution with just four ASICs, marking a significant advance in the density and performance of ultrasonic imaging technology.

Furthermore, this system may incorporate a third level of echo signal selection through the use of an aperture mechanism. As described above, this mechanism can be operated by the aperture address generator 5350, in conjunction with the calculation scheduler 5355, functioning as an aperture controller. It generates shift commands that allow the aperture to move either horizontally along a row or vertically along a column of the pulser matrix, adjusting by at least one pulser unit at a time (such as shifting by at least one of the columns or at least one of the rows). The shift can implement wrap-around functionality. For example, the aperture shifted out at the right can be shifted back in at the left, and the aperture shifted out at the bottom can be shifted back in at the top. The aperture can also be shifted between the two switch groups as it moves throughout the entire pulser matrix.

As an illustrative example, consider a 2×2 square aperture starting at the position defined by pulsers {#0, #1, #16, #17} within subset 6001 of switch group 6100. The aperture may then move horizontally by two pulsers to position {#2, #3, #18, #19} and continue this pattern until it has traversed the first two rows. It would then begin scanning the third and fourth rows, starting at {#32, #33, #48, #49}. In a vertical scanning scenario, the aperture similarly shifts by two pulsers to positions like {#32, #33, #48, #49}, continuing until the first and second columns are complete, and then moving to the third and fourth columns, starting at {#2, #3, #18, #19}. An alternative shifting pattern may involve moving the aperture to the corresponding position {#0, #1, #16, #17} in subset 6001 of the other switch group 6200, then returning to switch group 6100 at a subsequent position {#2, #3, #18, #19}, and so on until all pulsers have been encompassed within the scan cycle. It should be understood that these examples are illustrative and various other aperture shifting strategies or patterns may be used as long as the intended coverage of the targeted pulsers in the pulser matrix is achieved.

In addition, the configuration of this aperture can vary; it may be a rectangular shape activating four adjacent pulsers simultaneously or a larger aperture capable of engaging more pulsers, such as eight or sixteen, at once. The aperture can also be a sparse pattern where the RX switches are discretely distributed (i.e., a pattern in which non-neighboring pulsers are concurrently selected). The concurrent activation of these pulsers is achieved by precisely controlling the RX switches associated with each pulser, thereby enabling a refined and dynamic approach to signal reading and processing. The aperture's movement and positioning can be managed by the aperture address generator 5350, as previously mentioned.

The use of the aperture when reading signals may be advantageous, because the imaging can be limited to a smaller and dedicated part of the target object, and the routing between the RX channels and the pulser matrix can be streamlined. In addition, using the aperture to scan received signals, whether from a single ASIC or multiple ASICs, facilitates receipt of signals from a higher number of elements. For example, using the aperture in the example embodiment of FIGS. 1A and 1B permits signals to be received from 4,096 elements without connecting all the RX channels to all 4,096 elements to receive signals concurrently. Following the detailed descriptions of the dynamic configurations and shifting patterns of the aperture, a specific example of an imaging sequence within this system is outlined below, emphasizing the fast and efficient processing operations that are used in an example of high-resolution imaging:
1) The imaging sequence begins with the calculation of delays using the bicubic algorithm. This operation is for determining the precise timing required to transmit the ultrasonic pulses.
2) Next, the system activates all of the ASICs to transmit pulses in a sequence. These pulses are released using the delays calculated in the previous operation, ensuring precise timing and phase control for effective ultrasonic wave propagation.
3) The next operation is to load the aperture configuration parameters for the RX mode (such as switch group, subset, and aperture pattern) into all the ASICs. This operation sets up the system to properly receive and process echo signals from the transducers.
4) The system then updates the aperture configuration by adjusting the shift commands (offset values for each time on both the horizontal and vertical axes). This operation is repeated for all the ASICs, typically with identical values, to ensure consistent receive patterns.
5) With the configuration set, the system proceeds to acquire data for analysis through the ADCs for 64 channels. This process converts the analog echo signals into digital form, making them ready for further analysis and image reconstruction.
6) Operations 4) and 5) are then repeated a total of 64 times (4,096 elements/64 channels; each time with an offset applied). This iterative process, encompassing the entirety of the 4,096 elements through the 64 channels, systematically constructs a complete synthetic receive aperture. Given that operation 4) occurs 64 times more frequently than operation 1), it is beneficial to maintain its execution time to less than 1 microsecond, ensuring swift and efficient processing throughout the cycle.
7) Upon completion of these cycles, the system loops back to operation 1).

On the other hand, in TX mode, the activation sequence of the pulser matrix may be arranged to ensure that not all pulsers are activated at the same time. For example, activation may occur one column at a time, beginning with an entire column of switch group 6100, which contains 32 pulsers. This pattern continues with subsequent columns being activated in turn, progressing through all columns of both switch groups in a systematic cycle. The interval between activating successive columns can be approximately 200 picoseconds. It should be understood, however, that the grouping of pulsers for simultaneous activation can vary, for it is not limited to 32 pulsers. Activation may include a partial column, multiple columns, an entire row, a partial row, multiple rows, or even a rectangular block consisting of multiple rows and columns. This flexible approach to pulser grouping allows for customized activation patterns to meet the specific needs of the ultrasonic system. Additionally, the skew between the fastest and slowest pulser activation can range from 4.3 ns to 14.6 ns, depending on the process corner. This timing variation is integral to the system's design, ensuring precise control over the timing of pulser activation and enhancing the overall effectiveness of the ultrasonic imaging process.

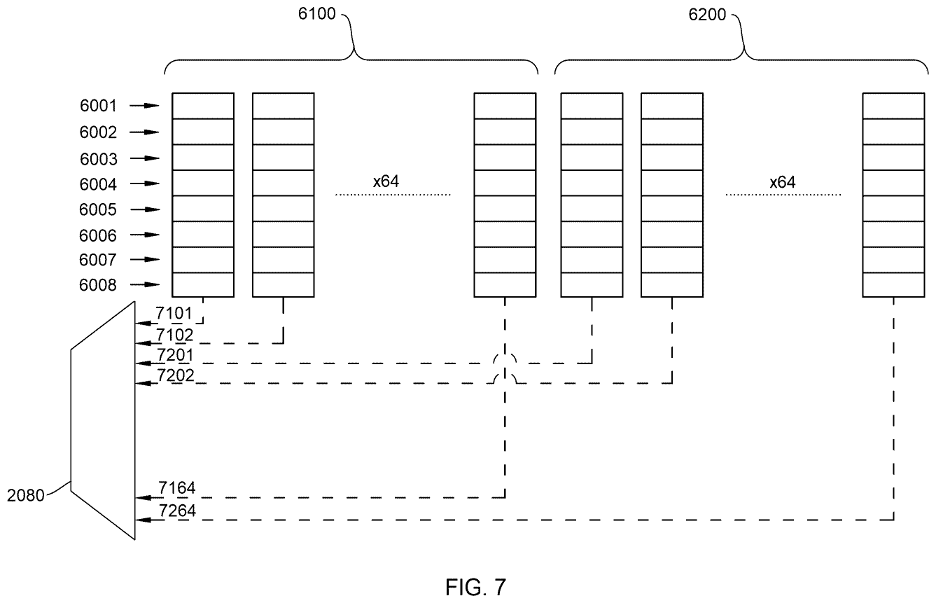

FIG. 7 shows a schematic of the routing strategy for the pulser matrix arrangement shown in FIG. 6. In this schematic, the pulsers are organized into the same two switch groups 6100 and 6200 and eight distinct subsets 6001 through 6008 as in FIG. 6. Within each switch group, pulsers with the same numbering follow a common signal path, as shown by the dashed lines in FIG. 7. For example, within group 6100, the paths for the 1^{st}, 2^{nd}, and 64^{th} pulsers are shown as 7101, 7102, and 7164, respectively. Similarly, in group 6200, the paths for the 1^{st}, 2^{nd}, and 64^{th} pulsers are indicated by 7201, 7202, and 7264. These paths (2×64) are then routed to the corresponding RX channels in the RX circuit 2080.

Building on the described routing strategy in FIG. 7, it is noteworthy to consider the crosstalk characteristics within the pulser matrix, especially when all pulsers are operating in the RX-phase. In such a scenario, the crosstalk from the entire matrix to a single RX channel is measured at −56 dB, under a worst-case assumption where all PZTs receive the same amplitude and phase. Additionally, the crosstalk level from one actively TX pulser to a RX pulser is measured at −75.8 dB. It is important to note that this measurement is relative to the transmitted signal strength from the TX pulser, rather than the strength of the received echo signal at the RX pulser.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or part of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is only for the purpose of describing particular embodiments and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. Then, when terms “approximately” and “about” are employed in relation to numerical values, they are intended to encompass a variation of plus or minus 10% from the stated number.

Phrases such as “at least one of A, B, and C”, “at least one of A, B, or C”, “one or more of A, B, and C”, and “A, B, and/or C” are intended to include both a single item from the enumerated list of items (i.e., only A, only B, or only C) and multiple items from the list (i.e., A and B, B and C, A and C, and A, B, and C). Accordingly, the phrases “at least one of”, “one or more of”, and similar phrases when used in conjunction with a list are not meant to require that each item of the list be present, although each item of the list may be present.

It is contemplated that any part of any aspect or embodiment discussed in this specification can be implemented or combined with any part of any other aspect or embodiment discussed in this specification, so long as such those parts are not mutually exclusive with each other.

While every effort has been made to provide a detailed and accurate description of the disclosure herein, it should be noted that the scope of the disclosure is not limited to the exact configurations and embodiments described. The description provided is intended to illustrate the principles of the disclosure and not to limit the disclosure to the specific embodiments illustrated. It is intended that the scope of the disclosure be defined by the appended claims, their equivalents, and their potential applications in other fields.

1. An application-specific integrated circuit (ASIC) for ultrasonic wave transmission and reception, the ASIC comprising:
a pulser matrix comprising a two-dimensional matrix of pulsers and a two-dimensional matrix of receive switches for electrical coupling to a two-dimensional matrix of ultrasonic transducer elements, wherein each of the pulsers is configured to produce pulses for a respective one of the ultrasonic transducer elements and wherein each of the receive switches is selectively configurable to conduct echo signals generated by a respective one of the ultrasonic transducer elements in response to receiving echoes of the pulses; and
at least one multiplexer stage communicatively coupled to the receive switches to receive the echo signals from the ultrasonic transducer elements, wherein the at least one multiplexer stage outputs a subset of the echo signals in response to a selection signal.

2. The ASIC of claim 1, wherein:
the matrix of receive switches is divided into multiple switch groups;
the at least one multiplexer stage comprises a first multiplexer stage and a second multiplexer stage communicatively coupled in series;
the first multiplexer stage comprises a switch line selectably couplable to different subsets of the switch groups such that the first multiplexer stage outputs the echo signals received from a selected one of the subsets from each of the switch groups; and
the second multiplexer stage outputs the echo signals from a selected one of the switch groups.

3. The ASIC of claim 2, wherein each of the switch groups comprises a grouping of one of columns or rows of the matrix of receive switches, and wherein each of the subsets comprises a grouping of the other of the columns or the rows of the matrix of receive switches.

4. The ASIC of claim 3, wherein each of the switch groups comprises a continuous sequence of one of the columns or the rows of the matrix of receive switches, and wherein each of the subsets comprises a continuous sequence of the other of the columns or the rows of the matrix of receive switches.

5. The ASIC of claim 3, wherein the echo signals are analog signals, and wherein the switch line selects the different subsets of the switch groups in response to a digital signal, and wherein the analog and digital signals are routed orthogonally to each other.

6. The ASIC of claim 4, wherein the matrix of receive switches is divided into two of the switch groups, the switch line is selectably couplable to eight different subsets of the switch groups, and any one of the subsets of either of the switch groups consists of 64 of the receive switches.

7. The ASIC of claim 4, further comprising a digital circuit comprising an aperture controller that generates shift commands to control an aperture that enables multiple of the receive switches to concurrently conduct the echo signals.

8. The ASIC of claim 7, wherein the aperture controller is configured to shift the aperture along the columns or rows in response to the shift commands.

9. The ASIC of claim 7, wherein the shift commands comprise shifting by one of the rows, shifting by one of the columns, and shifting to corresponding positions among the switch groups.

10. The ASIC of claim 1, wherein the ASIC further comprises test circuitry, and wherein the pulses output by the at least one multiplexer stage are routed on the ASIC to the test circuitry.

11. The ASIC of claim 1, further comprising a pulser logic circuit having a number of pulser control elements configured to generate control signals to manage timing of the pulses produced by the pulsers, wherein the pulser logic circuit is configured to pulse different groups of the pulsers sequentially with a delay between pulsing of the different groups.

12. The ASIC of claim 11, wherein each of the different groups of the pulsers consists of one or more pulsers in a column or a row of the pulser matrix.

13. The ASIC of claim 12, wherein the delay between the pulses produced by successive groups of the pulsers is between approximately 200 ps to approximately 400 ps.

14. The ASIC of claim 11, wherein the pulser control elements are configured to maintain the corresponding pulsers at a ground state in response to the pulsers not receiving the control signals to produce the pulses.

15. The ASIC of claim 1, further comprising output pads accessible from outside of packaging of the ASIC and respectively communicatively coupled to the pulsers and receive switches, and wherein the pulsers are positioned adjacent and directly connected to respective ones of the output pads.

16. A system, comprising:
a substrate;
a two-dimensional matrix of ultrasonic transducer elements arranged on one side of the substrate; and
a plurality of application-specific integrated circuits (ASICs) arranged on the other side of the substrate, each of the ASICs comprising:
a pulser matrix comprising a two-dimensional matrix of pulsers and a two-dimensional matrix of receive switches each respectively electrically coupled to the two-dimensional matrix of ultrasonic transducer elements, wherein each of the pulsers is configured to produce pulses for a respective one of the ultrasonic transducer elements and wherein each of the receive switches is selectively configurable to conduct echo signals generated by a respective one of the ultrasonic transducer elements in response to receiving echoes of the pulses; and
at least one multiplexer stage communicatively coupled to the receive switches to receive the echo signals from the ultrasonic transducer elements, wherein the at least one multiplexer stage outputs a subset of the echo signals in response to a selection signal.

17. The system of claim 16, wherein the system comprises at least four of the ASICs, and wherein each of the ASICs comprises at least 1,024 of the pulsers and receive switches.

18. The system of claim 17, wherein:
the matrix of receive switches is divided into multiple switch groups;
the at least one multiplexer stage comprises a first multiplexer stage and a second multiplexer stage communicatively coupled in series;
the first multiplexer stage comprises a switch line selectably couplable to different subsets of the switch groups such that the first multiplexer stage outputs the echo signals received from a selected one of the subsets from each of the switch groups; and
the second multiplexer stage outputs the echo signals from a selected one of the switch groups.

19. The system of claim 17, wherein each of the ASICs further comprises a pulser logic circuit having a number of pulser control elements configured to generate control signals to manage timing of the pulses produced by the pulsers, wherein the pulser logic circuit is configured to pulse different groups of the pulsers sequentially with a delay between pulsing of the different groups.

20. A method for operating an ultrasonic imaging system, wherein the system comprises:
a substrate;
a two-dimensional matrix of ultrasonic transducer elements arranged on one side of the substrate; and
a plurality of application-specific integrated circuits (ASICs) arranged on the other side of the substrate, wherein each of the ASICs comprises:
a pulser matrix comprising a two-dimensional matrix of pulsers and a two-dimensional matrix of receive switches each respectively electrically coupled to the two-dimensional matrix of ultrasonic transducer elements; and
at least one multiplexer stage communicatively coupled to the receive switches;
and wherein the method comprises:
generating pulses in at least one of the pulsers in at least one of the ASICs for a respective one of the ultrasonic transducer elements;
generating echo signals by the ultrasonic transducer elements in response to receiving echoes of the pulses;
selectively configuring at least one of the receive switches in at least one of the ASICs to conduct the echo signals; and
outputting a subset of the echo signals from the receive switches by the at least one multiplexer stage in response to a selection signal.
